(19) United States
(12) Patent Application Publication
(10) Pub. No.: US 2006/0285571 A1
(43) Pub. Date: Dec. 21, 2006

(54) Diode-pumped, solid-state laser with chip-shaped laser medium and heat sink

(76) Inventors: Yunlong Sun, Beaverton, OR (US); Brian Baird, Oregon City, OR (US)

Correspondence Address: STOEL RIVES LLP, 900 SW FIFTH AVENUE, SUITE 2600, PORTLAND, OR, 97204-1268, US

(21) Appl. No.: 11/157,271

(22) Filed: Jun. 20, 2005

(51) Int. Cl. H01S 3/04; H01S 3/16; H01S 3/091

(52) U.S. Cl. 372/71; 372/36; 372/41

(57) ABSTRACT

A chip-shaped laser medium (12) is side pumped to improve mode matching between the pumping energy (50) and lasing mode volume (36). The chip thickness (44) and laser medium doping level can be designed and controlled to ensure adequate pumping coupling efficiency. The chip shape can also be employed to provide greater chip surface areas (22) for cooling the laser medium (12). The laser pumping package (70), gain module (10₁), and chip-shaped design can be scalable to offer higher pumping power and high output power. Different orientations of the gain modules (10₁) with respect to each other can be used to provide better lasing mode quality.

### COPYRIGHT NOTICE

© 2005 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71 (d).

### TECHNICAL FIELD

The invention relates to diode-pumped, solid-state lasers and, in particular, to face pumping such a laser that has a chip-shaped laser medium.

### BACKGROUND OF THE INVENTION

Conventional diode-pumped, solid-state lasers typically employ end pumping or side pumping. For end pumping, the diode laser output is focused into an end surface (having smaller surface area than a side surface) of the lasing medium either directly or indirectly, such as through fiber, such that the pumping beam is coaxial with the lasing axis. An end-pumped laser medium typically has a rod, cubic, disk, chip, or other shape. For side pumping, the diode laser output is often directly coupled into the side surface of the laser medium such that the pumping beam is perpendicular to the lasing axis. A side-pumped laser medium typically has a rod, rectangular parallelepiped, cube, or slab shape.

End pumping generally has better mode matching between the pumping beam and the laser beam within a short distance around the focusing point of the pumping beam. End pumping also generally has a higher pumping coupling efficiency. However, since the pumping energy is concentrated into a small area, there is often severe thermal distortion in that region. Accordingly, end-pumping applications for higher laser power are somewhat limited. End pumping also generally requires the line-shaped pumping beam from one or more diode laser bars to be reshaped into a round-shaped pumping beam and/or coupling of the pumping beam into a pumping beam-delivering fiber. Nevertheless, conventional diode pumping designs have pursued the coupling efficiency at the expense of other considerations due to the high cost of the diode laser power.

Side pumping, as a contrast, typically distributes the pumping energy directly from the diode bar(s) into a wider region, so less thermal-induced distortion tends to occur and much higher pumping power can be applied. However, the mode matching and pumping efficiency for side pumping tend to be poorer than for end pumping.

An improved design for solid-state lasers is, therefore, desirable.

### SUMMARY

An object of the present invention is, therefore, to provide an improved solid-state laser.

To improve mode matching between the pumping energy and lasing mode volume in side-pumped solid-state laser designs, skilled persons may find it desirable to make the solid-state laser medium thin. However, rod-shaped lasing media, for example, become mechanically fragile when the rod becomes too thin, so it becomes difficult to make good thermal contact between the rod and a heat sink without damaging the rod.

In some embodiments, a chip-shaped lasing medium can be face pumped to improve mode matching between the pumping energy and lasing mode volume. The chip thickness and laser medium doping level can be designed and controlled to ensure adequate pumping coupling efficiency. The chip shape can also be employed to provide greater surface areas for cooling the laser medium. The laser pumping package and the chip-shaped design can be scalable to offer higher pumping power and high output power. In some exemplary scalable laser embodiments, a plurality of laser pumping packages can be employed to pump a single laser medium. In other exemplary scalable laser embodiments, multiple laser media are each pumped by a single laser pumping package. In yet other exemplary scalable laser embodiments, a single diode laser bar or array can be employed to pump a plurality of laser media. Different orientations of the laser pumping packages with respect to the mode volume of one or more laser media can be used to provide better lasing mode quality.

In some embodiments, a chip-shaped, solid-state laser medium has side surfaces that are transverse to and adjoin two generally planar opposing first and second faces with each face having a face surface area that is greater than a side surface area of any one of the side surfaces, such that the solid-state laser medium is adapted to emit solid-state laser output through at least one of its side surfaces in response to laser pumping light introduced through at least one of its faces. A first heat sink surface is in contact with or in proximity to the first face. A pumping source provides laser pumping light that is directed generally toward and transverse to the second face that is in contact with or proximity to a second heat sink surface, and the second heat sink is adapted to permit passage of the laser pumping light to impinge the second face.

Additional aspects and advantages will be apparent from the following detailed description of preferred embodiments, which proceeds with reference to the accompanying drawings.

### BRIEF DESCRIPTION OF THE DRAWINGS

FIG. 1 is a cross-sectional view of an exemplary diode-pumped, solid-state laser having a face-pumped, chip-shaped laser medium.

FIG. 2 is an enlarged isometric view of a chip-shaped laser medium.

FIG. 3 is an end view of an exemplary diode-pumped, solid-state laser having at least two laser pumping packages.

FIG. 4 is a simplified side view of a first alternative embodiment of the laser shown in FIG. 3.

FIG. 5 is a simplified side view of a second alternative embodiment of the laser shown in FIG. 3.

FIG. 6 is a simplified side view of a third alternative embodiment of the laser shown in FIG. 3.

FIG. 7 is a simplified side view of a fourth alternative embodiment of the laser shown in FIG. 3.

FIG. 8 is a simplified side view of an embodiment employing a diode laser to pump more than one laser medium.

FIG. 9 is a simplified side view of a fifth alternative embodiment of the laser shown in FIG. 3.

FIG. 10 is an end view of an exemplary diode-pumped, solid-state laser with gain modules having alternative orientations.

FIG. 11 is a cross-sectional view of an exemplary alternative diode-pumped, solid-state laser having a face-pumped, chip-shaped laser medium with an optical stripe adjacent to a gap in a heat sink.

### DETAILED DESCRIPTION OF PREFERRED EMBODIMENTS

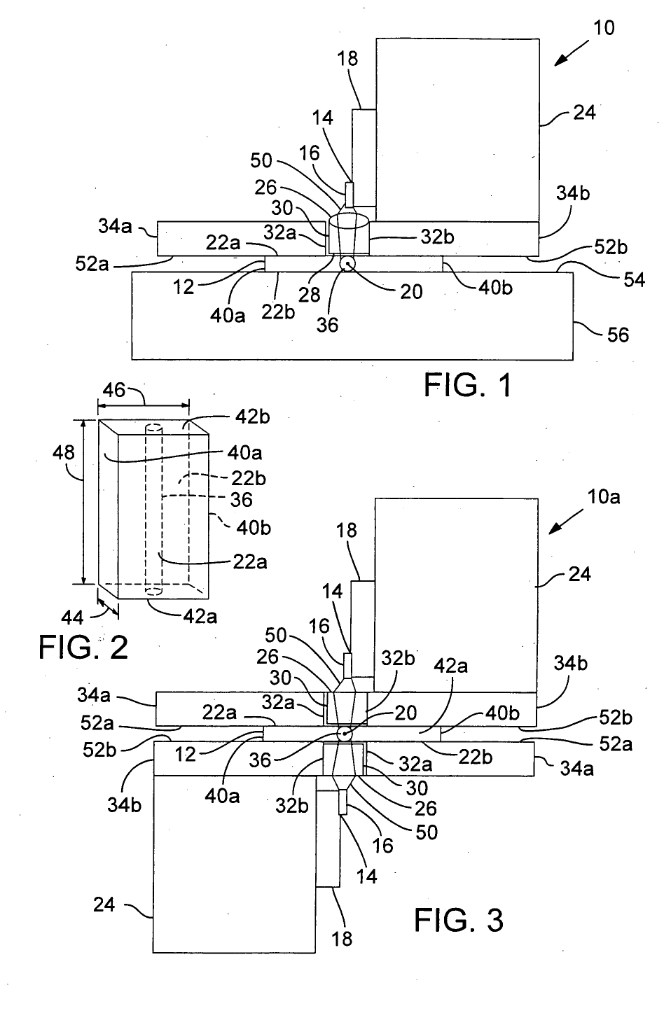

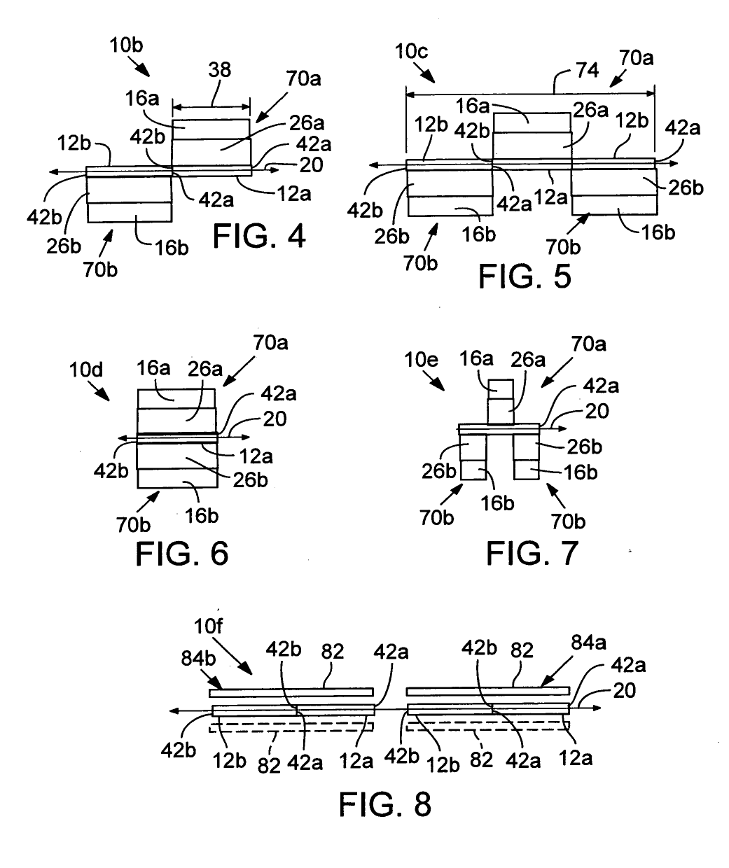

FIG. 1 shows a cross-sectional view of an exemplary solid-state laser 10 having a chip-shaped laser medium 12. A pumping source, such as one or more diode laser bars or arrays 16, with its heat sink 18 is positioned to pump with its pumping beam 50 the laser medium 12 on its chip face 22. The pumping source has a long dimension or length 38 (FIG. 4) that is generally aligned to be coplanar with or parallel to a lasing axis 20 of the laser medium 12. The direction of the pumping beam 50 is transverse, and preferably perpendicular, to the lasing axis 20 as well as transverse, and preferably perpendicular, to at least one of two large chip faces 22a or 22b (generically, large chip face 22).

The diode laser package 14, comprising the diode laser bar 16 and the heat sink 18, is preferably positioned against or connected to a temperature controlled heat sink 24 to maintain the diode laser bar 16 at a predetermined temperature. The diode laser bar 16 may include a single bar, multiple bars in parallel, or an array of bars whose output is directed or focused by an optical unit 26 into the laser medium 12. The diode laser package 14 may be an actively cooled stack, such that a liquid coolant is run through microchannels in the packaged stack of emitters. The output side of the diode laser bar 16 may be spaced apart from or in contact with or in proximity to the optical unit 26. In some embodiments, some spacing may be desirable to accommodate thermally related expansion and contraction of the various components or differences in their expansion coefficients. The pumping beam 50 can also be directly coupled into the chip face 22a without the intervening optical unit 26.

The optical unit 26 can include a single optical element or an assembly of multiple optical elements to deliver the pumping beam or output 50 of the diode laser bar 16 to the laser medium 12 by imaging or nonimaging optics. The optical unit 26 has a long dimension that is generally parallel to the lengths 38 and 48 (FIG. 2) of the diode laser bar 16 and the chip face 22. The length of the long dimension of the optical unit 26 is preferably about the same as the lengths 38 and/or 48, but may be longer or at a length in between them.

In some embodiments, the optical unit 26 is positioned with its chip-mating surface 28 in proximity to or in contact with the large chip face 22a of the laser medium 12. The optical unit 26 may have a circumferential side surface 30 or a plurality of side surfaces 30, some or all of which are preferably in proximity to or in contact with one or more inward sides 32a and/or 32b of one or more optical heat sinks 34a and/or 34b to provide conduction cooling. In some embodiments, some spacing may be desirable to accommodate thermally related expansion and contraction of the various components or differences in their expansion coefficients.

In some embodiments, the optical unit 26 includes a cylindrical lens or cylindrical lenses, a spherical lens or spherical lenses, a microlens array or microlens arrays, an aspheric lens or aspheric lenses, or any combination of the above lens components. Alternatively, the optical unit 26 may comprise one or more angled walls that are highly reflective to the emitted diode laser wavelength to guide the pumping beam 50 into a narrow pumping mode volume 36 that surrounds the thin lasing axis 20 of the laser medium 12. The optical unit 26 is made of any typical optical material, but preferably comprises a material such as undoped YAG or sapphire. Some embodiments of the optical unit 26 employ a nonimaging concentrator such as described in U.S. Pat. No. 5,323,414 of Baird et al. Exemplary optical units 26 preferably focus the pumping beam or energy 50 from the diode laser 16 into the laser medium 12 with very high mode matching between the pumping beam 50 and the lasing mode volume 36. The optical unit 26 may be diffusion bonded onto the laser medium 12 to enhance conduction cooling. In some embodiments, the optical unit 26, particularly as the cylindrical lens, can be an integrated part of the laser diode bar/array package 70 (FIG. 4).

FIG. 2 is an isometric view of an exemplary chip-shaped laser medium 12. With reference to FIG. 2, the laser medium 12 has two large chip faces 22a and 22b (generically, chip face 22), axial side surfaces 40a and 40b (generally, axial side surface 40), and nonaxial side surfaces 42a and 42b (generally, nonaxial side surface 42) that have planes that are generally transverse to the chip faces 22. The axial side surfaces 40 may be generally parallel to the lasing axis 20, but need not be so. The nonaxial side surfaces 42 are transverse, and preferably perpendicular, to or at a Brewster angle relative to the lasing axis 20, but need not be so.

The axial and nonaxial side surfaces 40 and 42 have short dimensions, which are preferably the same and which constitute a side thickness 44 of laser medium 12. The nonaxial side surfaces 42 have a long dimension, which constitutes a width 46 of laser medium 12. The axial side surfaces 40 have a long dimension, which constitutes a length 48 of laser medium 12. The chip faces 22 have surface areas that are greater than the surface areas of any of the axial or nonaxial side surfaces 40 and 42.

In some exemplary embodiments, the side thickness 44 is from about 1.5 mm to about 2 mm. In some exemplary embodiments, the width 46 is from about 6 mm to about 12 mm. The length 48 is generally as long as necessary to provide desirable pumping and emission characteristics, to the extent that such length is feasible. The length 48 may be matched to the length 38 of the diode laser bar 12. The exemplary thicknesses 44, widths 46, and lengths 48 may vary with the type of lasant material of laser medium 12 and/or its doping level.

With reference to FIGS. 1 and 2, a major portion of the chip face 22a that is not covered by the optical unit 26 is preferably in proximity to or in contact with heat sink faces 52a and 52b of the respective heat sinks 34a and 34b to facilitate conduction cooling. The heat sinks 34a and 34b may be spaced apart from each other or may be in contact with each other such that they may entirely surround the side surface(s) 30 of the optical unit 26. The heat sinks 34a and 34b may also be adapted to have inward sides or surfaces 32 that extend to be in proximity to or contact with the axial side surfaces 40 (and/or the nonaxial side surfaces 42 without occluding the lasing axis 20) to promote conduction cooling. The heat sinks 34a and 34b may constitute a single integrated heat sink 34 or may be divided in smaller heat sink sections.

A major portion of the chip face 22b is preferably in proximity to or in contact with a heat sink face 54 of a heat sink 56 to facilitate additional conduction cooling. The heat sink 56 may also be adapted to extend to be in proximity to or contact with the axial side surfaces 40 (and/or the nonaxial side surfaces 42 without occluding the lasing axis 20) to promote conduction cooling. The heat sink 56 may be divided in smaller heat sink sections that are contacting or noncontacting. The heat sink 56 may be adapted to be in proximity to or contact with one or more of the heat sinks 34. The heats sinks 34 and 56 may be adapted to form one or more integrated heat sink units that can be opened to allow placement of the laser medium 12. Alternatively, the heats sinks 34 and 56 may be adapted to form a single unit that permits laser medium 12 to be slid into place through an opening.

The chip faces 22 of the laser medium 12 can be soldered onto the heat sinks 34 and 56 when a proper coating is employed. The chip faces 22 (except for the optical window about the chip-mating surface of the optical unit 26 to allow for laser pumping) can, for example, be coated with gold and/or tin so the chip faces 22 can be soldered onto the heat sink faces 52 and 54 of the respective heat sinks 34 and 56 that may also be coated with gold and/or tin or other highly reflective metal or other solderable dielectric coating. The portion of the chip face 22b is preferably coated with gold to provide good reflection of the pumping beam 50. A tin coating can be then applied outside of the gold coating to facilitate soldering to a gold-coated heat sink face 54.

When the nonaxial side surfaces 42 are substantially perpendicular to the lasing axis 20, they can be coated with an AR coating at the lasing wavelength of the solid-state laser output. The entire nonaxial side surface 42 can be coated, or some area thereof that covers the ends of the mode volume 36. When the nonaxial side surfaces 42 are at a Brewster angle with respect to the lasing axis 20, they can be uncoated. External resonator mirrors (not shown) can also be employed to generally define a resonator.

If the optical window of the chip face 22a about the chip-mating surface of the optical unit 26 is not diffusion bonded to the optical unit, the optical window of the chip face 22a may be coated with an antireflective (AR) coating suited to pass pumping wavelength(s) that pump the specific lasant material of the laser medium 12. Similarly, the heat sink face 54 of the heat sink 56 can be polished and coated to specifically reflect the pumping wavelength(s). The laser medium 12 may comprise any solid-state lasant, such as Nd:YAG, Tm:YAG, Yb:YAG, Nd:YLF, Cr:alexandrite, or Nd:YVO₄. Tailoring the doping level of these lasant materials to ensure adequate pumping energy coupling is well known, and variations are described in detail in U.S. Pat. No. 5,590,141 of Baird et al. An Nd:YVO₄ lasant material is preferred for some applications. In such applications, a diode laser bar or array 16 emitting at 808 nm is preferably employed, the optical window of the chip face 22a is preferably polished and coated to transmit 808 nm, and the heat sink face 54 of heat sink 56 is preferably polished and coated to reflect 808 nm. Nd:YVO₄ is one of the most efficient lasants available for use as a solid-state laser medium 12 and provides a high absorption coefficient, a wide absorption bandwidth, and a large stimulated-emission cross-section at the pumping wavelength of suitable diode laser bars 16. Nd:YVO₄ also offers several advantages over Nd:YAG and Nd:YLF lasants, including a higher gain and shorter storage time that allow Nd:YVO₄ to deliver shorter pulse widths at higher repetition rates, lower requirements for the temperature control and pumping wavelength of the diode laser bar 16, lower lasing threshold, better polarization and mode output quality, and higher slope efficiency.

Nd:YVO₄ lasants have at least one major drawback. The technology is not yet available to cost-effectively manufacture Nd:YVO₄ crystal lasants to have a length longer than about 20 to 30 mm. Unfortunately, the power obtainable from a laser medium 12 is proportional to its length within allowed pumping energy density limitations, so the length of the lasant crystal limits the output power obtainable from the lasant. Certain laser micromachining applications including, but not limited to, link blowing and via drilling would, however, benefit from greater power than a single Nd:YVO₄ lasant crystal 20 to 30 mm long can provide. In some of these applications, a total length of Nd:YVO₄ crystal lasants of at least 60 to 80 mm would be desirable. FIGS. 3-7 provide depictions of exemplary embodiments that can be employed to overcome this problem.

FIG. 3 is an end view of an exemplary diode-pumped, solid-state laser 10a (generically laser 10) having at least two laser pumping packages 70a and 70b (generically, laser pumping package 70), showing that the design of laser 10 is power scalable. With reference to FIG. 3, laser pumping packages 70a and 70b may contain some or all of the elements of laser 10. These elements have been labeled with reference numerals identical to those in FIG. 1 for convenience. These corresponding elements of laser pumping packages 70a and 70b may be identical or intentionally different to satisfy particular laser applications.

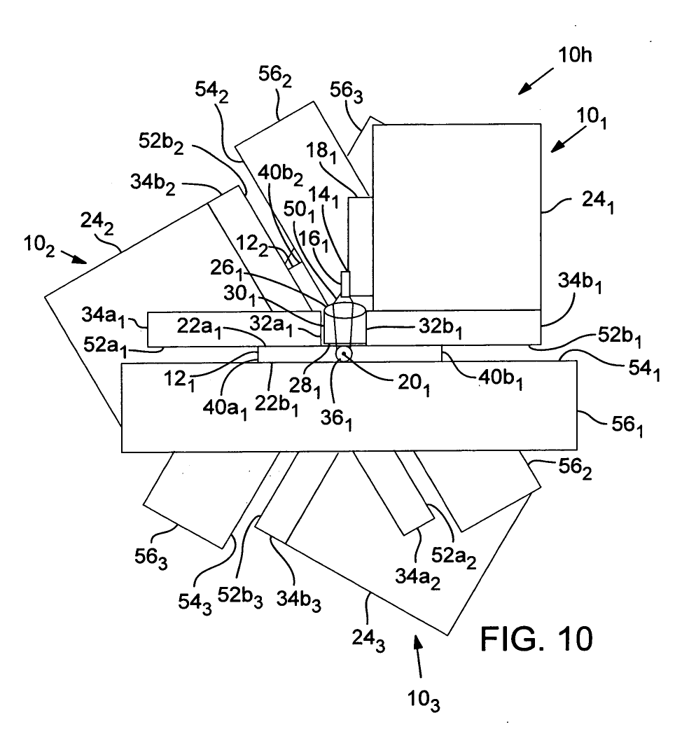

In some embodiments (such as shown in FIGS. 4 and 5), each laser pumping package 70a and 70b may be directed into a separate laser medium 12 accompanied by its own heat sink 56 (not shown in FIG. 3). Thus, each laser pumping package 70, laser medium 12, and heat sink 56 may be grouped or connected together to form separate gain modules 10₁, 10₂, and 10₃ (FIG. 10) that have their respective mode volumes 36 aligned along a common lasing axis 20. By sharing a common lasing axis 20, the gain modules 10₁ can provide desirable thermal properties and a desirable homogenized beam quality. The number of gain modules 10₁ can be scaled to any size or power requirement.

Where multiple gain modules 10₁ are positioned to be serially adjacent, the internal nonaxial side surfaces 42 may be coated with an AR coating. In some embodiments, particularly those employing continuous-wave (CW) operation, one of the external nonaxial side surfaces 42 may be coated with a highly reflective (HR) coating while the other external nonaxial side surface 42 may be coated with a partly reflective coating to permit solid-state laser output. In some alternative embodiments, particularly those employing Q-switched operation, one of the external nonaxial side surfaces 42 may be coated with an HR coating while the other external nonaxial side surface 42 may be coated with an AR coating to allow propagation through the Q-switch and to an external mirror. Alternatively, both external nonaxial side surfaces 42 may be coated with an AR coating and two external mirrors may be employed to define the resonator.

FIG. 4 is a simplified side view of a first alternative embodiment of the laser 10b (generically laser 10) shown in FIG. 3 wherein a plurality of laser media 12 (such as in separate gain modules 10₁) can be serially employed to provide a total effective lasant length 74 that is longer than the length 48 (and in some cases the length limitation) of a single laser medium 12. With reference to FIG. 4, for convenience only, the laser media 12a and 12b, the optical units 26a and 26b, and the diode laser bars 16a and 16b are shown of the respective laser pumping packages 70a and 70b. With reference to FIGS. 3 and 4, each laser pumping package 70 face pumps a separate laser medium 12. The laser media 12a and 12b are aligned to provide lasing action along a common lasing axis 20 and to effectively provide a single resonator. Different orientations of the laser pumping packages 70a and 70b with respect to the mode volume 36 of the laser media 12a and 12b are balanced to ensure better lasing mode quality. The chip faces 22 of laser media 12a and 12b are preferably aligned to be coplanar as shown in FIG. 4. However, skilled persons will appreciate that the planes of the chip faces 22 of the different laser media 12a and 12b could be transverse to each other as long as the mode volumes 36 of the laser media 12a and 12b are coaxially aligned. The adjoining nonaxial side surfaces 42a and 42b of the laser media 12a and 12b are in contact with or in proximity to each other and may be bonded together with or without optical coatings.

FIG. 5 is a simplified side view of a second alternative embodiment of the laser 10 shown in FIG. 3 wherein multiple laser media 12 (such as in separate gain modules 10₁) are serially employed to form a laser 10c (generically laser 10). With reference to FIG. 5, for convenience only, the laser media 12a and 12b, the optical units 26a and 26b, and the diode lasers 16a and 16b are shown of the respective laser pumping packages 70a and 70b. With reference to FIGS. 3-5, one or more additional sets of pumping packages 70a or 70b and laser media 12a or 12b can be added to the embodiment portrayed in FIG. 4, further demonstrating the scalability of the laser design. In one exemplary embodiment, the laser media 12 each have a length of at least 20 mm to provide a combined resonator length of at least 60 mm. Such embodiments could be particularly useful to increase the power capabilities of lasers employing Nd:YVO₄ crystal lasants. Different orientations of the laser pumping packages 70a and 70b with respect to the mode volume 36 are, however, employed to balance the lasing mode quality. The pumping packages 70 can also be evenly spaced or oriented to improve mode quality. The number of pumping packages 70 can also be adjusted to balance different orientations to further improve mode quality.

FIG. 6 is a simplified side view of a third alternative embodiment of the laser 10 shown in FIG. 3 wherein the lengths 38 of the diode laser bars 16 substantially overlap to form a laser 10d (generically laser 10). With reference to FIG. 6, for convenience only, the laser media 12a and 12b, the optical units 26a and 26b, and the diode laser bars 16a and 16b are shown of the respective laser pumping packages 70a and 70b. With reference to FIGS. 3 and 6, both laser pumping packages 70a and 70b face pump the same laser medium 12 to provide it with scalable pumping power. In this embodiment, the diode lasers 16a and 16b may be positioned on opposing chip faces 22 of a single laser medium 12 to emit coaxially.

FIG. 7 is a simplified side view of a fourth alternative embodiment of the laser 10 shown in FIG. 3 in which only the laser media 12a and 12b, the optical units 26a and 26b, and the diode laser bars 16a and 16b are shown of the respective laser pumping packages 70a and 70b. With reference to FIGS. 3 and 7, each laser pumping package 70 face pumps the same laser medium 12 to form a laser 10e (generically laser 10). In this embodiment, the diode laser bars 16a and 16b are positioned on opposing chip faces 22 of a single laser medium 12 to pump a common mode volume 36.

Skilled persons will appreciate that any of the embodiments shown and described with respect to FIGS. 3-5 and 7 could be implemented so that the laser pumping packages 70 are arranged side by side instead of on opposing sides of laser media 12.

FIG. 8 is a simplified side view of a laser 10f (generically laser 10) employing a diode laser 82 to pump more than one laser medium 12. With reference to FIG. 8, laser 10f employs at least one elongated diode laser 82 to face pump coplanar chip faces 22 of at least two laser media 12a and 12b aligned to have a common lasing axis 20. The nonaxial sides 42a and 42b of the laser media 12a and 12b are preferably perpendicular to or at a Brewster angle to the lasing axis 20, and they may be spaced apart (not shown) or may be in proximity to or in contact with each other as discussed with respect to other embodiments employing a plurality of laser media 12. An additional diode laser 82 may be similarly positioned to face pump the opposing coplanar chip faces 22. This embodiment is also power scalable as each diode laser 82 may be employed to pump multiple laser media 12, or laser 80 may employ a plurality of laser packages 84 (84a or 84b) that are aligned along the common lasing axis 20.

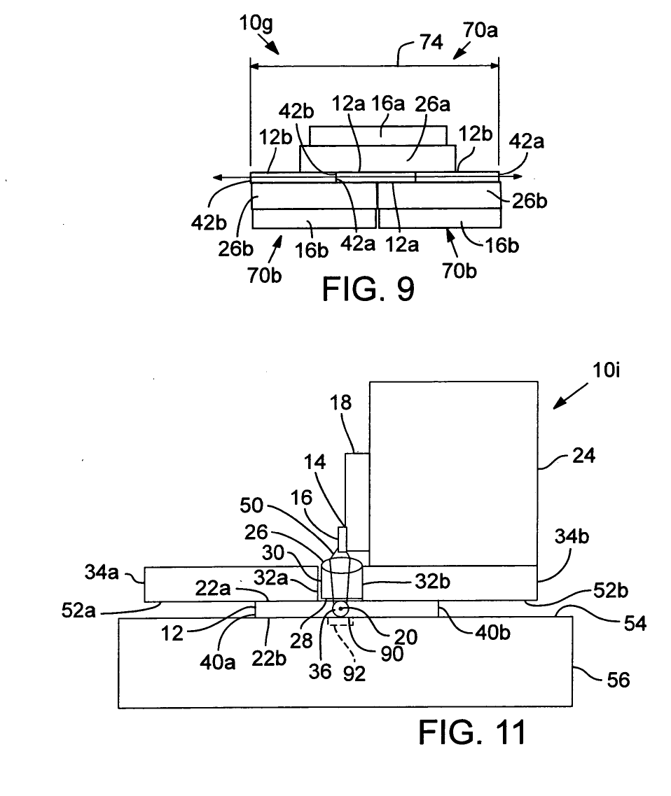

FIG. 9 is a simplified side view of a fifth alternative embodiment of the laser 10g (generically laser 10) shown in FIG. 3 wherein multiple laser media 12 are serially employed to form a laser 10g. With reference to FIG. 9, for convenience only, the laser media 12a and 12b, the optical units 26a and 26b, and the diode laser bars 16a and 16b are shown of the respective laser pumping packages 70a and 70b. With reference to FIGS. 3 and 9, the diode laser bars 16 are arranged along opposing chip faces 22 such that the lengths 38 of the opposing laser diode bars 16 partly overlap. The diode laser bars 16a and 16b can have the same lengths 38 or different lengths 38, and the diode laser bars 16b can be in contact with or in proximity to each other or spaced apart.

FIG. 10 is an end view of an exemplary diode-pumped, solid-state laser 10h (generically laser 10) with gain modules 10₁, 10₂, and 10₃ (generically gain module(s) 10₁) having alternative orientations while maintaining generally collinear alignment of their respective mode volumes 36 and lasing axes 20. With reference to FIGS. 3-5 and 10, FIGS. 3-5 depict laser pumping packages 70 (or gain modules 10₁) oriented about 180 degrees apart around mode volume 36 and lasing axis 20. FIG. 10 specifically shows three gain modules 10₁, 10₂, and 10₃ that are oriented generally about 120 degrees apart with respect to their positioning about their commonly aligned mode volumes 36 and collinear lasing axes 20.

In some embodiments, improved spatial distribution of pump output 50 in the serially positioned mode volumes 36 can be achieved through selective azimuthal orientation of the gain modules 10₁, 10₂, and 10₃ with respect to mode volume 36. In some embodiments, 360 degrees is divided by the number of serial gain modules 10₁ to be employed to determine a uniform degree of separation to provide evenly spaced gain modules 10₁. In other embodiments, the degrees of separation can be a factor of the uniform degree of separation, e.g., six gain modules 10₁ may be serially separated by 120 degrees to provide regularly spaced gain modules 10₁. Skilled persons will also appreciate that the orientations of the gain modules 10₁ do not need to be regularly or evenly spaced. Any angular or azimuthal orientations or spacings are possible and may be determined by desirable optical and thermal properties of the laser 10h.

FIG. 11 is a cross-sectional view of an exemplary alternative diode-pumped, solid-state laser 10i (generically laser 10) having a face-pumped, chip-shaped laser medium 12 with an optical stripe 90 adjacent to a gap 92 in a heat sink 56. The optical stripe 90 is preferably as wide as, or wider than, the diameter of the mode volume 36. The optical stripe 90 may comprise an optical coating that is reflective to the wavelengths of the pumping beam 50 while the rest of chip face 22b may be coated with materials more suitable for facilitating bonding with heat sink surface 54. The optical stripe 90 may reflect unabsorbed pumping output 50 back into the mode volume 36 to increase pumping efficiency.

The heat sink 56 may optionally also be provided with a gap or recess 92 in the heat sink surface 54. The recess 92 is preferably as wide as the optical stripe 90 and need not be very deep. The recess 92 need not have a rectangular cross-section, and alternative exemplary cross-sectional shapes may be triangular or curved such as semicircular. The recess 92 may be filled with air, may be evacuated or connected to a vacuum source (not shown), or may be liquid cooled. The recess 92 may be employed to simplify the optical coating applied to the optical stripe 90 and may sacrifice a small amount of conduction cooling in exchange for improved pumping efficiency. The laser 10i can be used as one or more of the gain modules 10₁ in any previously described embodiment.

The embodiments described herein provide high-power diode-pumped IR or other wavelength laser gain modules 10₁ with power scalability, better cooling of the laser medium 12, good laser mode quality, adequate pump coupling efficiency, high repetition rate capability, and simplicity in design for cost savings during manufacturing.

It will be obvious to those having skill in the art that many changes may be made to the details of the above-described embodiments without departing from the underlying principles of the invention. The scope of the present invention should, therefore, be determined only by the following claims.

1. A solid-state laser, comprising:
a chip-shaped, solid-state laser medium having side surfaces that are transverse to and adjoin two generally planar opposing first and second chip faces, each chip face having a face surface area that is greater than a side surface area of any one of the side surfaces, and the solid-state laser medium being adapted to emit solid-state laser output through at least one of the side surfaces in response to laser pumping light introduced through at least one of its chip faces;
a first heat sink having a first heat sink surface in contact with the first chip face such that a first major portion of the surface area of the first chip face contacts the first heat sink surface;
a pumping source for providing laser pumping light;
an optical unit for directing the pumping light generally toward and transverse to the second face; and
a second heat sink having a second heat sink surface in contact with the second chip face such that a second major portion of the surface area of the second chip face contacts the second heat sink surface, the second heat sink adapted to permit passage of the laser pumping light to impinge the second chip face.

2. The solid-state laser of claim 1 in which the pumping source comprises a diode laser bar or a diode laser array.

3. The solid-state laser of claim 1 in which the optical unit comprises a focusing cylindrical lens that passes through the second heat sink.

4. The solid-state laser of claim 3 in which the lens comprises undoped YAG or sapphire.

5. The solid-state laser of claim 1 in which the optical unit forms an integrated part of a diode laser package that comprises a diode laser bar and a diode laser heat sink.

6. The solid-state laser of claim 1 in which the optical unit comprises an aperture through the second heat sink with highly reflective slanted walls.

7. The solid-state laser of claim 1 in which the first and/or second chip faces are at least partly coated with a reflective metal or other solderable dielectric coating.

8. The solid-state laser of claim 1 in which the first and second heat sink surfaces belong to separate heat sinks.

9. The solid-state laser of claim 1 in which the laser medium has a lasing axis along which the laser output propagates, in which one of the side surfaces is a lasing side surface through which the laser output propagates, and in which the lasing side surface is at Brewster angle relative to the lasing axis.

10. The solid-state laser of claim 1 in which the laser medium has a lasing axis along which the laser output propagates, in which one of the side surfaces is a lasing side surface through which the laser output propagates, in which the lasing side surface is substantially perpendicular to the lasing axis, and in which the lasing side surface has an anti-reflective coating at a lasing wavelength of the solid-state laser output.

11. The solid-state laser of claim 1 in which the laser medium is a first laser medium, in which the first laser medium has a lasing axis, and in which a second chip-shaped, solid-state laser medium is aligned along the lasing axis, the second chip-shaped laser medium having opposed third and fourth chip faces and side surfaces such that a side surface of the laser medium is in proximity to or in contact with a side surface of the second laser medium.

12. The solid-state laser of claim 11 in which the first and third chip faces are generally coplanar.

13. The solid-state laser of claim 11 in which the first and third chip faces have planes with angular orientations with respect to each other.

14. The solid-state laser of claim 13 in which the first laser medium has a first length and the second laser medium has a second length, in which the first and second laser media have a manufacturing length limitation such that the first and second lengths are less than or equal to the length limitation, and in which the first and second laser media provide a total resonator length that is greater than the length limitation.

15. The solid-state laser of claim 14 in which the first and/or second laser media comprise: Nd:YAG, Yb:YAG, Nd:YLF, Nd:YVO₄, Tm:YAG, or Cr:alexandrite.

16. The solid-state laser of claim 14 further comprising first and second diode laser heat sinks that are associated with respective first and second diode laser bars or arrays to form respective first and second diode laser packages, and in which the first diode laser package is positioned to pump the first laser medium and the second diode laser package is positioned to pump the second laser medium.

17. The solid-state laser of claim 1 in which the laser medium has a lasing axis along which the laser output propagates and in which the pumping source has a long dimension that is generally parallel to the lasing axis.

18. The solid-state laser of claim 17 in which the pumping source comprises a diode laser bar or a diode laser array.

19. The solid-state laser of claim 1 in which the laser medium comprises: Nd:YAG, Yb:YAG, Nd:YLF, Nd:YVO₄, Tm:YAG, or Cr:alexandrite.

20. The solid-state laser of claim 1 in which the second chip face has an anti-reflective coating at a wavelength of the pumping light.

21. The solid-state laser of claim 1 in which the first and/or second heat sink constitutes an assembly of a plurality of heat sinks such that they have respective generally coplanar first and/or second surfaces that contribute to the respective first and/or second heat sink surface.

22. The solid-state laser of claim 1 in which the optical unit comprises nonimaging optics.

23. The solid-state laser of claim 1 in which the pumping light comprises a pumping wavelength, in which the laser medium has a lasing axis along which the laser output propagates, in which the laser medium has a mode volume effectively positioned about the lasing axis, in which the laser medium has an optical stripe on its first chip face such that the optical stripe is generally aligned with the mode volume and is reflective to the pumping wavelength.

24. The solid-state laser of claim 23 in which the first heat sink comprises a recess adjacent to the optical stripe.

25. A method for scaling power output from a solid-state laser, comprising
generating first laser pumping light from a first pumping source having a long dimension that generally defines a first pumping length;
directing the first pumping light generally toward and transverse to at least a first chip face of a first chip-shaped, solid-state laser medium having opposed first interior and exterior nonaxial side surfaces that are transverse to and adjoin the first chip face, the first chip face having a first face surface area that is greater than a first side surface area of either of the first interior or exterior nonaxial side surfaces, the first laser medium having a first lasing axis that is transverse to the first interior and first exterior nonaxial side surfaces;
generating second laser pumping light from a second pumping source having a long dimension that generally defines a second pumping length;
directing the pumping light generally toward and transverse to at least a second chip face of a second chip-shaped, solid-state laser medium having opposed second interior and exterior nonaxial side surfaces that are transverse to and adjoin the second chip face, the second chip face having a second face surface area that is greater than a second side surface area of either of the second interior or exterior nonaxial side surfaces, the second laser medium having a second lasing axis that is transverse to the second interior and exterior nonaxial side surfaces and is collinear with the first lasing axis, and at least a portion of the first and second interior nonaxial side surfaces being in proximity to or in contact with each other; and
emitting, in response to the first and second laser pumping light, solid-state laser output along the collinear first and second lasing axes that pass through at least one of the first or second exterior nonaxial side surfaces, the collinear first and second lasing axis being generally parallel to the long dimensions of the first and second pumping sources.

26. The method of claim 25 in which the first and second pumping sources each comprise a diode laser bar or a diode laser array.

27. The method of claim 25 in which the first laser medium has a first length along the collinear first and second lasing axis and the second laser medium has a second length along the collinear first and second lasing axis, in which the first and second lengths have a limit imposed by a manufacturing process, and in which the first and second laser media have a combined length that is greater that the limit imposed by the manufacturing process.

28. The method of claim 25 in which the first and second laser media comprise: Nd:YAG, Yb:YAG, Nd:YLF, Nd:YVO₄, Tm:YAG, or Cr:alexandrite.

29. The method of claim 25 in which first and second diode laser heat sinks are associated with respective first and second diode laser bars or arrays to form respective first and second diode laser packages, and in which the first diode laser package is positioned to pump the first laser medium and the second diode laser package is positioned to pump the second laser medium.

30. The method of claim 25, further comprising:
generating additional respective laser pumping light from additional respective pumping sources having additional respective long dimensions that generally define additional respective pumping lengths;
directing the additonal respective pumping light generally toward and transverse to additional respective chip faces of additional respective chip-shaped, solid-state laser media having opposed additonal respective interior nonaxial side surfaces that are transverse to and adjoin the additonal respective chip faces, the additonal respective chip faces having additional respective face surface areas that are greater than additional respective side surface areas of the additional respective interior nonaxial side surfaces, the additional respective laser media having additional respective lasing axes that are transverse to the additional respective interior nonaxial side surfaces and are collinear with the first lasing axis, and at least a portion of the additional respective interior nonaxial side surfaces being in proximity to or in contact with adjacent interior nonaxial side surfaces; and
emitting, in response to the first, second, and additonal respective laser pumping light, solid-state laser output along the collinear first, second, and additional respective lasing axes that pass through at least one of the first or second exterior nonaxial side surfaces, the collinear first, second, and additional respective lasing axes being generally parallel to the additional respective long dimensions of the additional respective pumping sources, and the first, second, and additional respective chip faces being angularly offset by an equivalent angle.

31. A solid-state laser, comprising:
a chip-shaped, solid-state laser medium having side surfaces that are transverse to and adjoin two generally planar opposing first and second chip faces, each chip face having a face surface area that is greater than a side surface area of any one of the side surfaces, and the solid-state laser medium being adapted to emit solid-state laser output along a lasing axis through at least one of the side surfaces in response to laser pumping light introduced through the first chip face, the laser medium having a mode volume effectively positioned about the lasing axis;
a pumping source for providing laser pumping light at a pumping wavelength generally along a pumping length that is generally parallel to the lasing axis;
an optical unit for directing the pumping light generally toward and transverse to the first chip face;
an optical stripe on the first chip face such that the optical stripe is generally aligned with the mode volume and is reflective to the pumping wavelength; and
a heat sink having a heat sink surface in contact with the second chip face, the heat sink having a recess in the heat sink surface adjacent to the optical stripe.

32. The solid-state laser of claim 31 in which the second chip face is at least partly coated with a reflective metal or other solderable dielectric coating in second chip face areas other than where the optical stripe is located.

33. The solid-state laser of claim 31 in which the optical stripe is wider than or equal to the diameter of the mode volume.

34. The solid-state laser of claim 31 in which the optical stripe has a stripe width, in which the recess has a recess width, and in which the recess width is wider than or equal to the stripe width.

35. A method for generating solid-state laser output, comprising:
generating laser pumping light from a diode laser bar or diode laser array having a long dimension that generally defines a pumping length;
directing the pumping light generally toward and transverse to at least one of the first or second chip faces of a chip-shaped, solid-state laser medium having side surfaces that are transverse to and adjoin the two generally planar opposing first and second chip faces, each chip face having a face surface area that is greater than a side surface area of any one of the side surfaces;
emitting solid-state laser output along a lasing axis that passes through at least one of the side surfaces in response to the laser pumping light, the lasing axis being generally parallel to the long dimension of the diode laser bar or array; and
reducing heat generated in the solid-state laser medium through conduction between the first and second faces and respective first and second heat sink surfaces, wherein the first and/or second heat sink is adapted to permit passage of the laser pumping light to impinge the respective first and/or second face.
